(19) United States
(12) Patent Application Publication
(10) Pub. No.: US 2016/0116665 A1
(43) Pub. Date: Apr. 28, 2016

(54) ILLUMINATION SYSTEM

(71) Applicant: HON HAI PRECISION INDUSTRY CO., LTD., New Taipei (TW)

(72) Inventors: FU-KUO HUANG, New Taipei (TW); CHIH-HANG CHAO, New Taipei (TW)

(21) Appl. No.: 14/552,156

(22) Filed: Nov. 24, 2014

(30) Foreign Application Priority Data
Oct. 28, 2014 (TW) 103137288

(51) Int. Cl. F21V 8/00

(52) U.S. Cl. CPC G02B 6/0066; G02B 6/0075

(57) ABSTRACT

An illumination system includes a light source for emitting a light and an adjustable structure. The adjustable structure is configured to house the light source. The adjustable structure includes an outlet, at least one light guide unit, and a linking portion. The outlet is configured to allow the light to extend through the adjustable structure. The light guide unit is configured to transmit the light from the light source to the outlet. The linking portion is deformable and configured to adjust a distance between the outlet and the light source.

### FIELD

The present disclosure relates to an illumination system.

### BACKGROUND

An illumination area is based on a light emitting position of a light source. Usually, a position of the light source in an illumination system is stable; thereby the light emitting position of the light source is also stable.

### BRIEF DESCRIPTION OF THE DRAWINGS

Implementations of the present technology will now be described, by way of example only, with reference to the attached figures.

FIG. 1 is an exploded view of an illumination system in accordance with an embodiment.

FIG. 2 is a pre-assembled view of the illumination system of FIG. 1.

FIG. 3 is an assembled view of the illumination system of FIG. 1.

FIG. 4 is a diagrammatic view of light of the illumination system in accordance with an embodiment.

FIG. 5 is another assembled view of the illumination system in accordance with an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to an illumination system. The illumination system includes a light source for emitting a light and an adjustable structure. The adjustable structure is configured to house the light source. The adjustable structure includes an outlet, at least one light guide unit, and a linking portion. The outlet is configured to allow the light to extend through the adjustable structure. The light guide unit is configured to transmit the light from the light source to the outlet. The linking portion is deformable and configured to adjust a distance between the outlet and the light source.

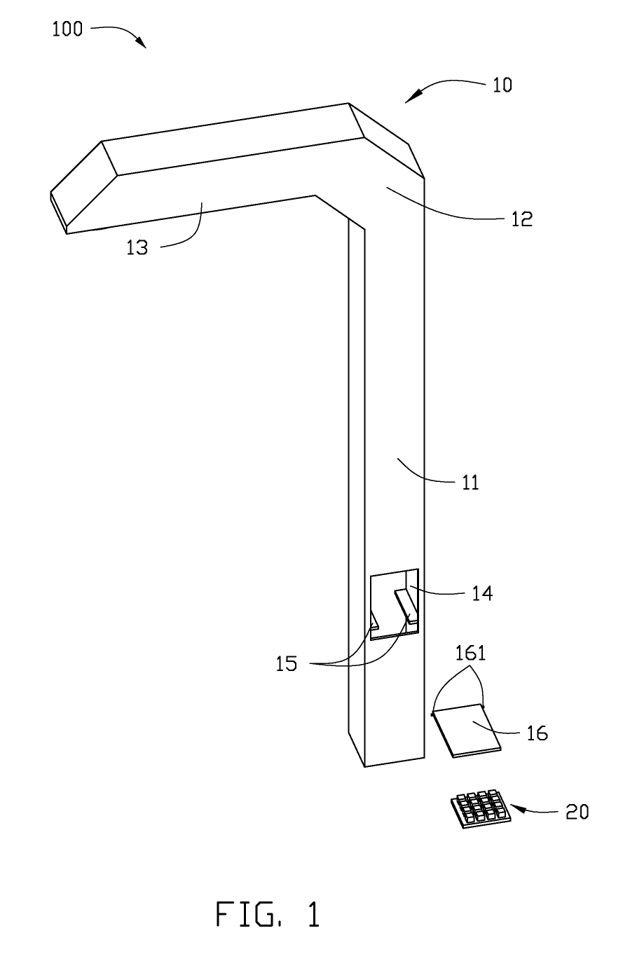

FIG. 1 illustrates that an illumination system 100 includes a light source 20 and an adjustable structure 10. The adjustable structure 10 is configured to adjust a light emitting position of the light source 20. In at least one embodiment, the illumination system 100 may be a lamp system or a dome light system, and the light source 20 is a light emitting diode (LED) or an incandescent bulb.

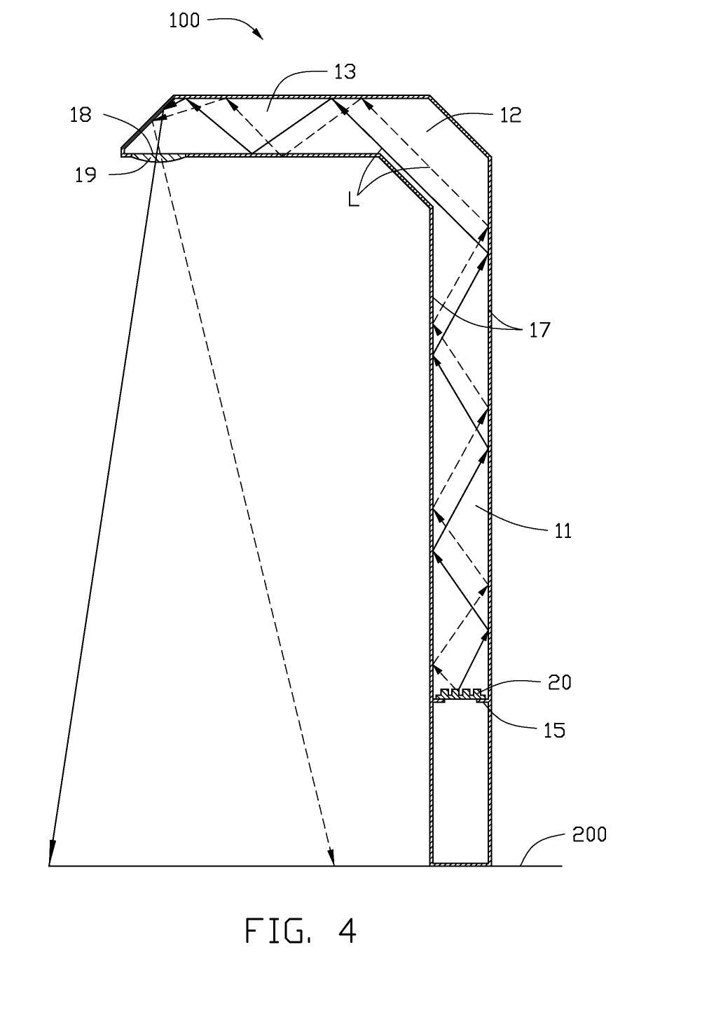

The adjustable structure 10 is hollow for housing and covering the light source 20. In alternative embodiments, the cross section of the adjustable structure 10 is a rectangle, a circle, or can be other geometrical shapes. The adjustable structure 10 includes a first portion 11, a second portion 13, and a linking portion 12 coupled between the first portion 11 and the second portion 13. The linking portion 12 is deformable and configured to adjust an angle between the first portion 11 and the second portion 13. When the linking portion 12 is in an original state, an axial direction of the first portion 11 is substantially perpendicular to an axial direction of the second portion 13, and an axial direction of the linking portion 12 is substantially inclined relative to the axial direction of first portion 11. The linking portion 12 is coupled between a top of the first portion 11 and a proximal end of the second portion 13. Thereby the second portion 13 is coupled to the top of the first portion 11 by the linking portion 12. In at least one embodiment, the axial direction of the first portion 11 is substantially vertical to a horizontal plane 200 (shown in FIG. 4), and the axial direction of the second portion 13 is substantially parallel to the horizontal plane 200 (shown in FIG. 4). The linking portion 12 can be made of plastic material and is configured to be bent or rotated.

An inlet 14 is defined in the first portion 11. The size of the inlet 14 is large enough for placing the light source 20 into the first portion 11. Two support members 15 extend from two internal surfaces of the first portion 11 for supporting the light source 20. The light source 20 can be mounted on the support members 15 by screwing, pasting, or other manners. The first portion 11 further includes a cover 16 for covering the inlet 14. Two pivot portions 161 extend from opposite sides of the cover 16 and are configured to pivotably latch the cover 16 to the first portion 11.

FIG. 4 illustrates that an outlet 18 for allowing a light L to extend through the adjustable structure 10 is defined in a distal end of the second portion 13. The light L from the light source 20 is configured to transmit along the extending direction of the adjustable structure 10 and emit from the outlet 18. In at least one embodiment, a height of the outlet 18 is greater than a height of the light source 20. In at least one embodiment, the outlet 18 is covered by a lampshade 19.

The adjustable structure 10 further includes a plurality of light guide units 17. Each light guide unit 17 is positioned inside the adjustable structure 10 and is configured to transmit the light L from the light source 20 to the outlet 18. In at least one embodiment, the light guide units 17 are evenly located on the internal surfaces of the adjustable structure 10. In another embodiment, all the internal surfaces of the adjustable structure 10 are completely covered by the light guide units 17. In one embodiment, each light guide unit 17 is made of reflection material such a mirror surface.

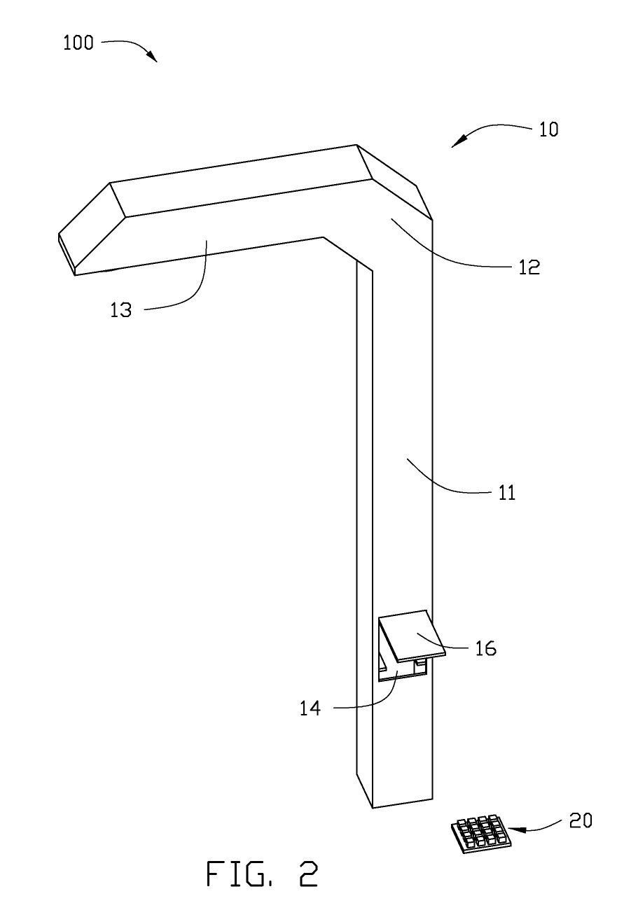

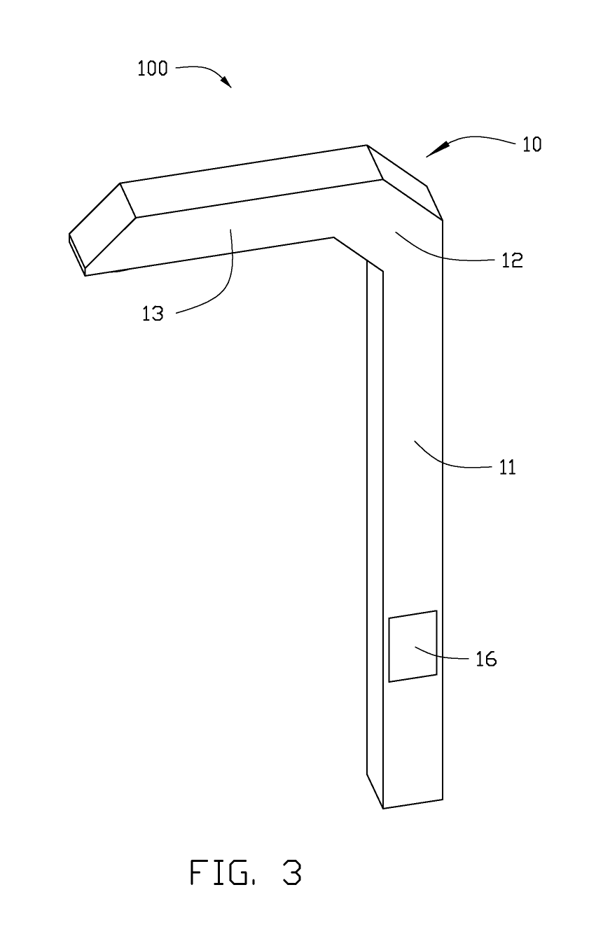

FIGS. 2-3 illustrate an assembled view of the illumination system 100. The light source 20 is secured into the first portion 11 via the inlet 14. The inlet 14 is covered by the cover 16. Thereby the light source 20 is housed inside and completely covered by the adjustable structure 10, the light L from the light source 20 can emit only through the outlet 18.

FIG. 4 illustrates that in one embodiment, the illumination system 100 is positioned on the horizontal plane 200. A height between the light source 20 and the horizontal plane 200 is less than a height between the outlet 18 and the horizontal plane 200. The light guide units 17 located inside the first portion 11 are configured to transmit the light L from the light source 20 to the top of the first portion 11. The light L inside the adjustable structure 10 is configured to transmit from the top of the first portion 11 to the second portion 13 via the linking portion 12. The light guide units 17 located inside the second portion 13 are configured to transmit the light L to the outlet 18. In at least one embodiment, the light L has total reflection inside the adjustable structure 10.

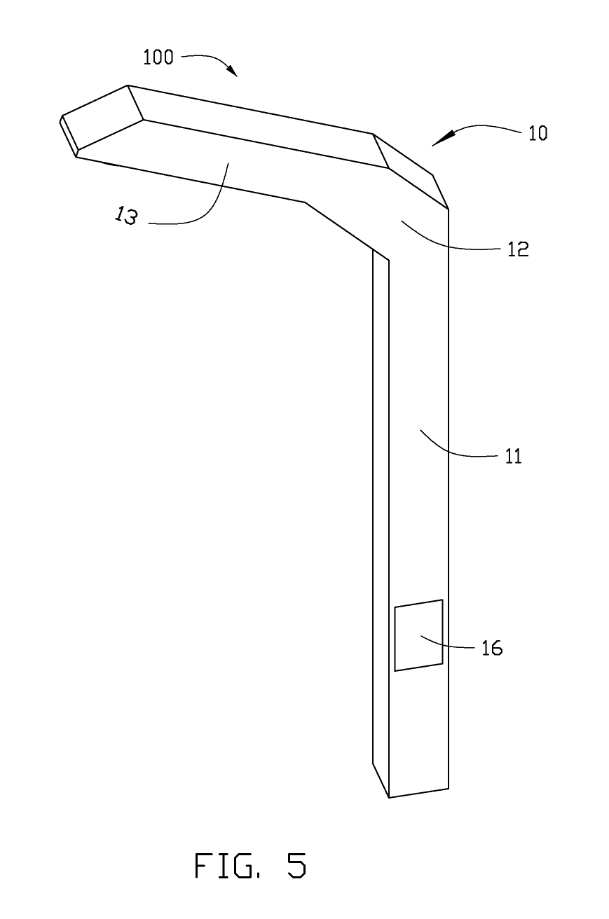

The linking portion 12 is deformable allowing adjustment of the relationship between the first portion 11 and the second portion 13 into a plurality of positions. The light guide units 17 are configured to transmit the light L emitted by the light source 20 to the outlet 18 when the relationship between the first portion 11 and the second portion 13 is in any of the plurality of positions. FIG. 5 illustrates that the first portion 11 and the second portion 13 is in one of the positions. The angle between the first portion 11 and the second portion 13 is adjusted by the deformation of the linking portion 12. Thereby, even the lengths of the first portion 11 and the second portion 13 are constant values; a distance between the outlet 18 and the light source 20 is also adjusted by the linking portion 12. The light emitting positions of the light source 20 can be adjusted by the deformation of the linking portion 12.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An illumination system comprising:
a light source configured to emitting a light; and
an adjustable structure configured to house the light source, having:
an outlet configured to allow the light to extend through the adjustable structure;
at least one light guide unit, configured to transmit the light from the light source to the outlet; and
a linking portion deformable and configured to adjust a distance between the outlet and the light source.

2. The illumination system of claim 1, wherein a height of the outlet is greater than a height of the light source.

3. The illumination system of claim 1, wherein the adjustable structure is hollow for housing the light source, and the light guide unit is located on an internal surface of the adjustable structure.

4. The illumination system of claim 2, wherein all the internal surfaces of the adjustable structure are covered by the light guide unit.

5. The illumination system of claim 1, wherein the adjustable structure further comprises a first portion, and the light source is housed inside the first portion.

6. The illumination system of claim 2, wherein the light guide unit is located inside the first portion and is configured to transmit the light from the light source to a top of the first portion.

7. The illumination system of claim 5, wherein the adjustable structure further comprises a second portion, and the outlet is defined in the second portion.

8. The illumination system of claim 7, wherein the linking portion is coupled between the first portion and the second portion, and the light inside the adjustable structure transmits from the first portion to the second portion via the linking portion.

9. The illumination system of claim 7, wherein the light guide unit is located inside the second portion and is configured to transmit the light to the outlet.

10. The illumination system of claim 1, wherein the cross section of the adjustable structure is a rectangle or a circle.

11. An illumination system comprising:
a light source configured to emitting a light; and
an adjustable structure configured to adjust a light emitting position of the light source, having:
an outlet configured to allow the light to extend through the adjustable structure;
a first portion, a linking portion, and a second portion, the linking portion deformable and coupled between the first portion and the second portion; and
at least one light guide unit, configured to transmit the light from the light source to the outlet;
wherein the light source is housed in the adjustable structure, the light from the light source is configured to transmit along the extending direction of the adjustable structure.

12. The illumination system of claim 11, wherein a height of the outlet is greater than a height of the light source.

13. The illumination system of claim 11, wherein the adjustable structure is hollow, the light guide unit is located on an internal surface of the adjustable structure.

14. The illumination system of claim 11, wherein the light has total reflection inside the adjustable structure.

15. The illumination system of claim 11, wherein the light source is housed inside the first portion, and the light guide unit is located inside the first portion and is configured to transmit the light from the light source to a top of the first portion.

16. The illumination system of claim 11, wherein the outlet is defined in the second portion, and the light guide unit is located inside the second portion and is configured to transmit the light to the outlet.

17. The illumination system of claim 16, wherein the second portion is coupled to a top of the first portion, and the outlet is defined in a distal end of the second portion.

18. The illumination system of claim 11, wherein an angle between the first portion and the second portion is adjusted by the linking portion.

19. The illumination system of claim 11, wherein a support member extends inside the adjustable structure for supporting the light source; and the light source is covered by adjustable structure.

20. An illumination system comprising:
a substantially hollow first portion;
a substantially hollow second portion;
a substantially hollow linking portion connecting the first portion to the second portion;
a light source positioned within an interior of the first portion to emit light toward the linking portion;
an outlet defined in the second portion and allowing light to transfer from an interior of second portion; and
one or more light guide units positioned in at least one of the interior of the first portion, the interior of the second portion and an interior of the linking portion;
wherein, the linking portion is deformable allowing adjustment of the relationship between the first portion and the second portion into a plurality of positions; and
wherein, the one or more light guide units are configured to transmit the light emitted by the light source to the outlet when the relationship between the first portion and the second portion is in any of the plurality of positions.
